(19) United States
(12) Patent Application Publication
(10) Pub. No.: US 2007/0200035 A1
(43) Pub. Date: Aug. 30, 2007

(54) Modular retail merchandise display system

(75) Inventors: Samuel R. Chamberlain III, Frisco, TX (US); Christine A. Courtney, Irving, TX (US)

Correspondence Address: FULBRIGHT & JAWORSKI L.L.P, 2200 ROSS AVENUE, SUITE 2800, DALLAS, TX, 75201-2784, US

(73) Assignee: Exhibitgroup/Giltspur, a division Viad Corp, Phoenix, AZ (US)

(21) Appl. No.: 11/361,674

(22) Filed: Feb. 24, 2006

(51) Int. Cl. F16L 3/00

(52) U.S. Cl. 248/121

(57) ABSTRACT

A three dimensional modular retail display system and method for constructing the system where the three dimensional modular retail display comprises a base assembly, vertical members, horizontal members, various connector pieces, and display elements. The vertical members contain display connection elements that allow a retailer to connect industry-standard display elements to the vertical members without the use of additional hardware. The modular system allows a retailer to create free-standing displays containing various structural shapes and various display elements while maintaining a uniform look to the overall display. Such a free standing display may be place on the main counter of a Retail Merchandising Unit (RMU).

### CROSS-REFERENCE TO RELATED APPLICATIONS

This application is related to concurrently filed and commonly assigned U.S. patent application Ser. No. [Attorney Docket No. 66477-P004US-10601573] entitled “ROTATABLE CONNECTOR FOR A DISPLAY SYSTEM”, the disclosure of which is hereby incorporated herein by reference.

### TECHNICAL FIELD

The following description relates generally to display systems, such as display systems employed in retail stores for merchandising, and more particularly to assembling a display from various components to form a uniform modular display for displaying retail merchandise.

### BACKGROUND OF THE INVENTION

Many businesses use Retail Merchandising Units (RMUs) to establish an effective storefront through which they can conduct retail sales in public areas, such as shopping malls, theme parks, sports arenas, and a wide variety of other public venues. An RMU may, for example, be implemented as a kiosk or other structure. RMUs may be employed for a vendor (e.g., retailer) to market its merchandise to prospective customers and conduct sales transactions with customers. An RMU generally includes shelves or other display mechanisms that rest on the counter of the RMU for displaying the vendor's merchandise to prospective customers when the RMU is open for business. Other retail establishments employ similar structures. For example, a cosmetics counter at a department store may display merchandise in displays resting on the cosmetics counter.

Such displays generally consist of two components: an underlying support structure and display elements coupled to the support structure. Support structures include peg boards, slotted displays (e.g., slotted standards, slotted tubing, etc.), and other types of supports. Display elements include hangers, hooks, or other display mechanisms that are coupled to the support frame. One common type of support structure used for this purpose consists of a vertical plane of material that contains multiple connection points for attaching display elements. Such a display structure may, for example, take the form of a wire grid, a pegboard, or a sheet of material with slots for attaching standard shelving units. Slotted standards, vertical rods containing slots in which brackets may rest, are often attached to such a plane of material. FIG. 1A shows one embodiment of a prior art support structure referred to as a slatwall. Slats 10 and 11 serve as connection points for various display elements. FIGS. 1B and 1C show two examples of display elements that attach to the slatwall of FIG. 1A where the upper portion of the connection component slides into the slat and the lower portion rests in the slat below. The largely opaque backing of these displays obstructs customers' view of the merchandise when viewed from one side. Additionally, mall managers generally disfavor opaque displays within RMUs because the large displays tend block customers' views of storefronts on the other side of an RMU. These storefronts typically pay significantly higher rent than the RMUs. Thus, a desire exists for a display structure for RMUs that is less obstructive to those who wish to view merchandise from all sides, as well as those who wish to view other storefronts beyond an RMU.

Another common type of display structure for RMUs custom-designed stand-alone structures that rest on top of a countertop. Such a display may take the form of a single structure containing both support and display elements or a rigid free-standing support structure that contains connection points for display elements. FIGS. 2A and 2B illustrate stand-alone structures of the prior art, which are designed to sit on a countertop and which contain both support and display elements. Both figures show products designed to display bracelets. These displays do not allow the retailer to add or subtract display elements, nor do they allow the retailer to change the type of display elements. Thus, these are fixed or static displays that cannot be dynamically changed in their configuration by a user. FIG. 2C shows a spinning cube where each cube face contains slats 20 and 21 for connecting display elements. While the prior art display structure of FIG. 2C allows a retailer to add, remove, and change display elements, the support structure—a cube shape of set height and breadth—cannot be altered by the retailer. Additionally, the free standing displays discussed above are generally small, and an RMU may contain several of these small displays. The use of several displays often creates a lack of uniformity in the overall appearance of the RMU. Thus, a desire exists for a display structure that allows a retailer to create a uniform display, easily add and remove display elements, and dynamically alter the size and shape of the support structure of the display.

### BRIEF SUMMARY OF THE INVENTION

The present invention is directed generally to a modular display support structure. An embodiment of the support structure can be used for constructing a modular three-dimensional retail merchandise display comprising a base assembly, vertical members, horizontal members, connector pieces, and display elements. Through the use of various connectors, a retailer may easily create a modular display support structure in countless configurations using combinations of horizontal and vertical members selectively connected together. Any number of desired display elements can be connected to such support structure without the use of any additional connectors.

The vertical members of the modular support structure contain features to allow the retailer to attach various types of display elements (e.g., brackets for supporting shelves, hangers, hooks, etc.) thereto. In one embodiment, the vertical members are slotted tubes having slots that accommodate industry-standard connectors on opposing sides of such tubes. In one embodiment, the vertical members contain holes that allow the user to easily secure the members to connector pieces. The horizontal members similarly contain holes that allow the user to easily secure the horizontal members to the connector pieces and may contain features that allow the retailer to attach various display elements. In one embodiment, the horizontal members are a different size than the vertical members. This prevents confusion in construction of a display support structure.

According to one embodiment, the connector pieces and base assemblies connect or terminate various vertical and horizontal components to form a desired support structure. In one embodiment, the connector pieces range from one-way connectors to four-way connectors. A one-way connector attaches to the end of a horizontal or vertical member and caps it. A two-way connector attaches to two members. In one embodiment, one type of two-way connector connects two members of the same type (e.g., two vertical or two horizontal members). A spacer may be used between the two members being interconnected. A three-way connector connects two members of one type with a member of another type. The instance, a three-way connection may interconnect two vertical members together and also a horizontal member thereto. A four-way connector attaches two horizontal and two vertical members together. In one embodiment, the connectors may contain a spline that fits within an open end of the member and connects to the member. A base assembly similarly connects to one or more vertical or horizontal member and further contains a base support enabling the support structure to stand upright.

The modular retail merchandise display may contain display elements designed specifically for use with the modular support structure or industry-standard display elements obtained separately by the retailer. As discussed above, in one embodiment the vertical members may have slots designed to accept industry-standard connections, such as are commonly used on brackets for couple with slotted standards. The display elements may include jewelry bars, straight brackets, angled brackets, hooks, or any other structure used to display merchandise. The system may further contain graphical elements coupled to the modular display.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIGS. 1A-1C show a prior art opaque display and accompanying display elements.

FIGS. 2A-2C show a prior art free-standing display structures.

FIG. 3 shows an exemplary configuration of a modular support structure of one embodiment of the present invention.

FIGS. 4A-4D show various exemplary configurations in to which the modular support structure of FIG. 3 may be configured according to an embodiment of the present invention.

FIG. 5 shown an exemplary vertical member of the modular support structure of FIG. 3.

FIG. 6 shown an exemplary horizontal member of the modular support structure of FIG. 3.

FIGS. 7A and 7B show a one-way connector for a vertical according to one embodiment.

FIG. 8 shows a spacer element for a vertical member according to one embodiment.

FIG. 9 shows of a two-way spline for a vertical member according to one embodiment.

FIG. 10A shows a three-way connector according to one embodiment.

FIGURE 10B shows a four-way connector according to one embodiment.

FIG. 11 shows a base assembly according to one embodiment.

FIGS. 12A-12E show display elements for use with the modular support structure of one embodiment.

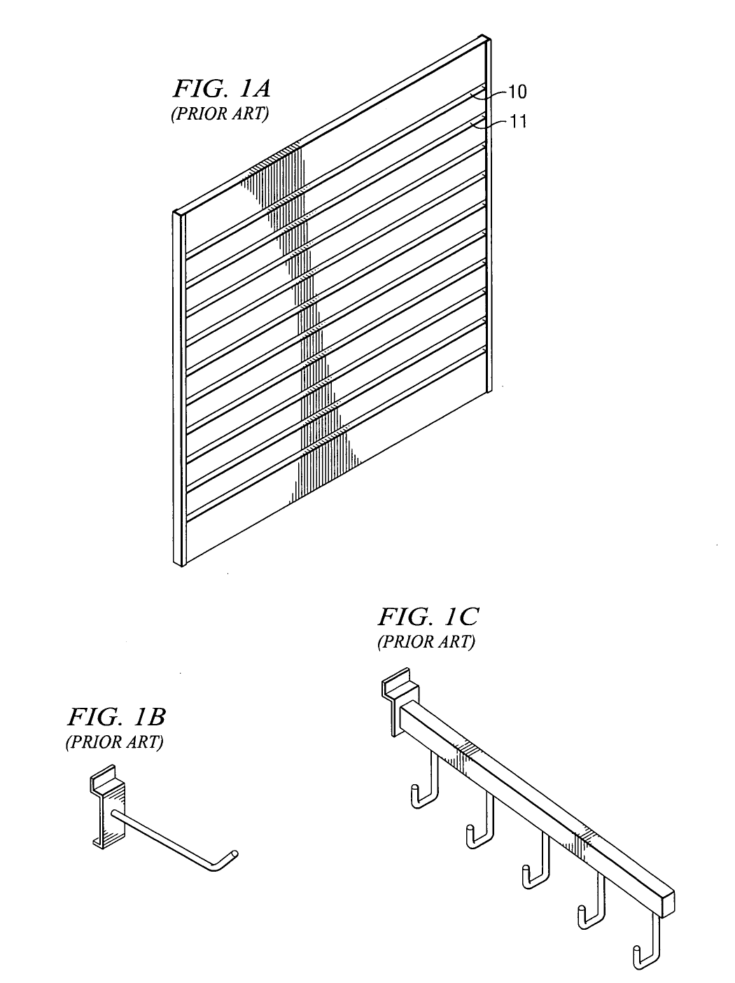

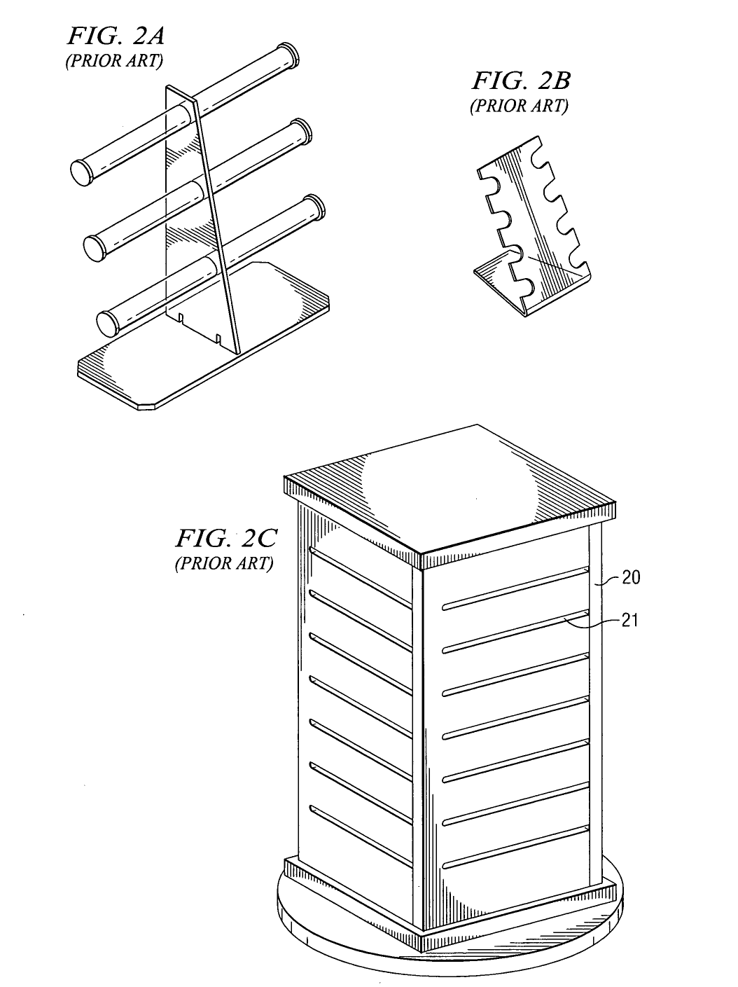

### DETAILED DESCRIPTION OF THE INVENTION

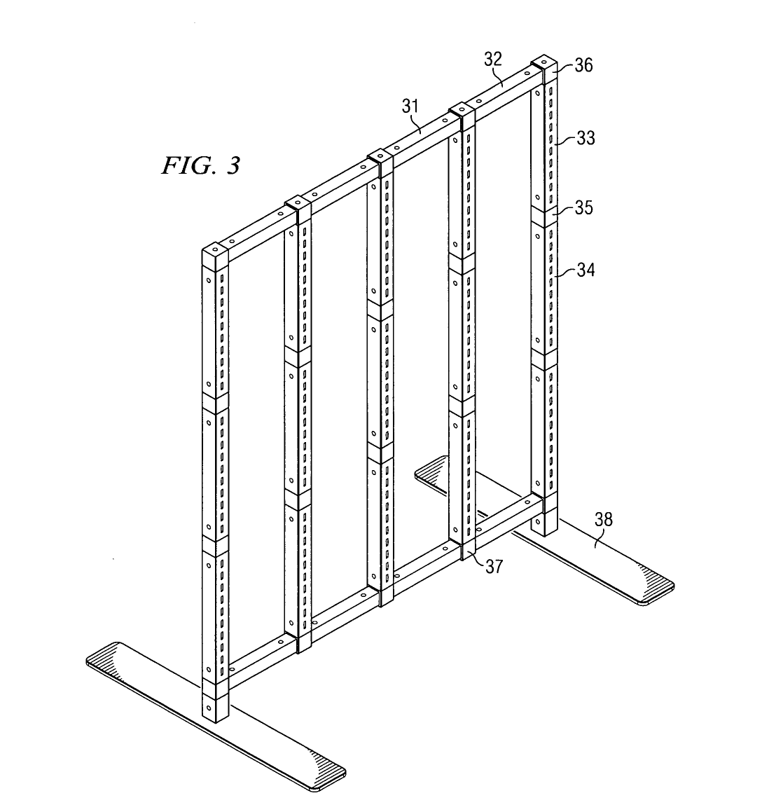

FIG. 3 shows an exemplary modular support structure according to one embodiment of the invention. A plurality of horizontal members 31 and 32 couple to other horizontal members and a plurality of vertical members 33 and 34 through the use of a plurality of connectors 35, 36, and 37. The stacked vertical members thus form a plurality of columns providing attachment points for display elements. Base assembly 38 is coupled to display support structure to enable the support structure to stand upright. In one embodiment, the plurality of vertical members and some of the plurality of connectors contain elements that serve as connection points for display elements. The vertical members 33 and 34 and horizontal members 31 and 32 may be selectively coupled to form a number of different support structures as may be desired for a given display application.

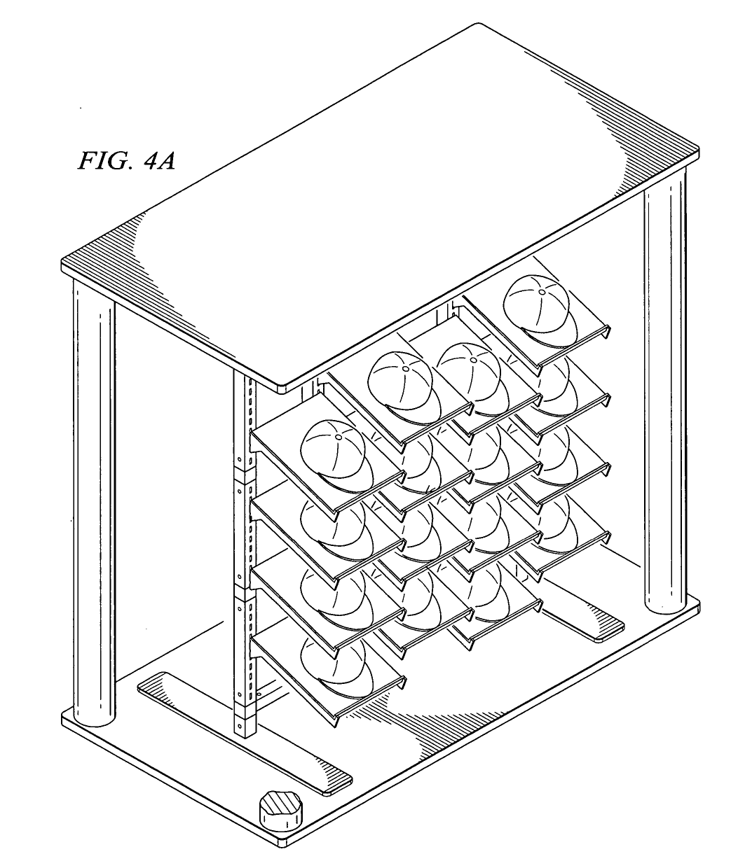

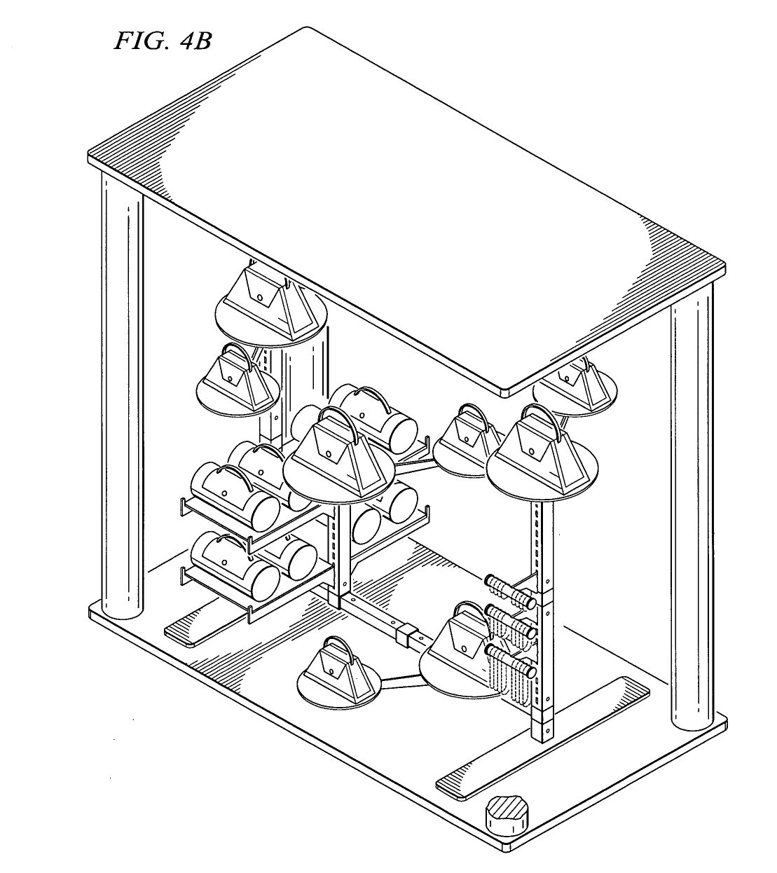

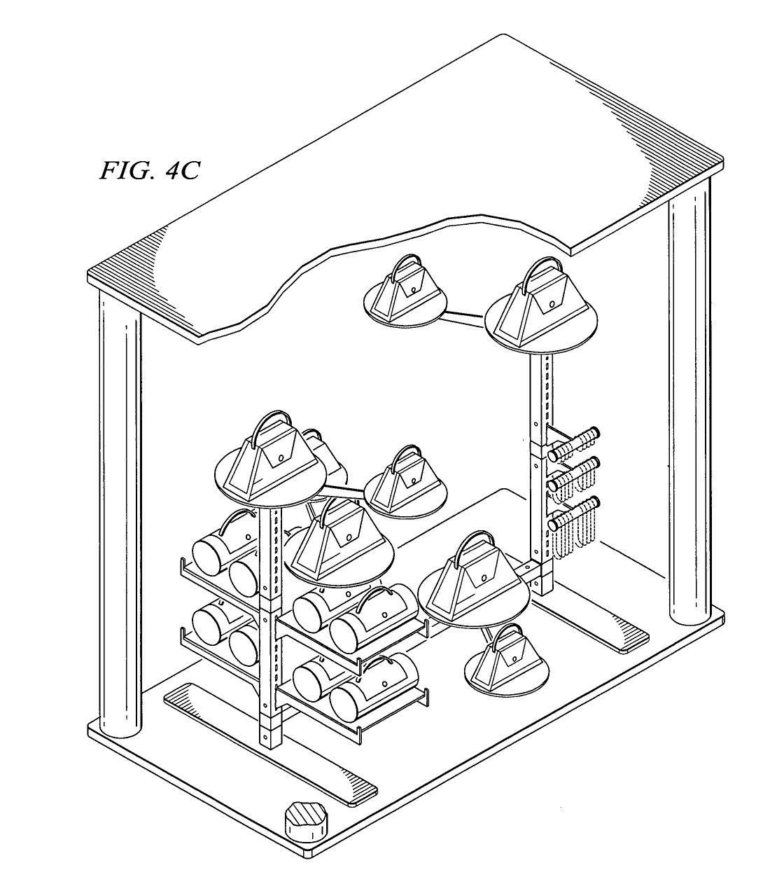

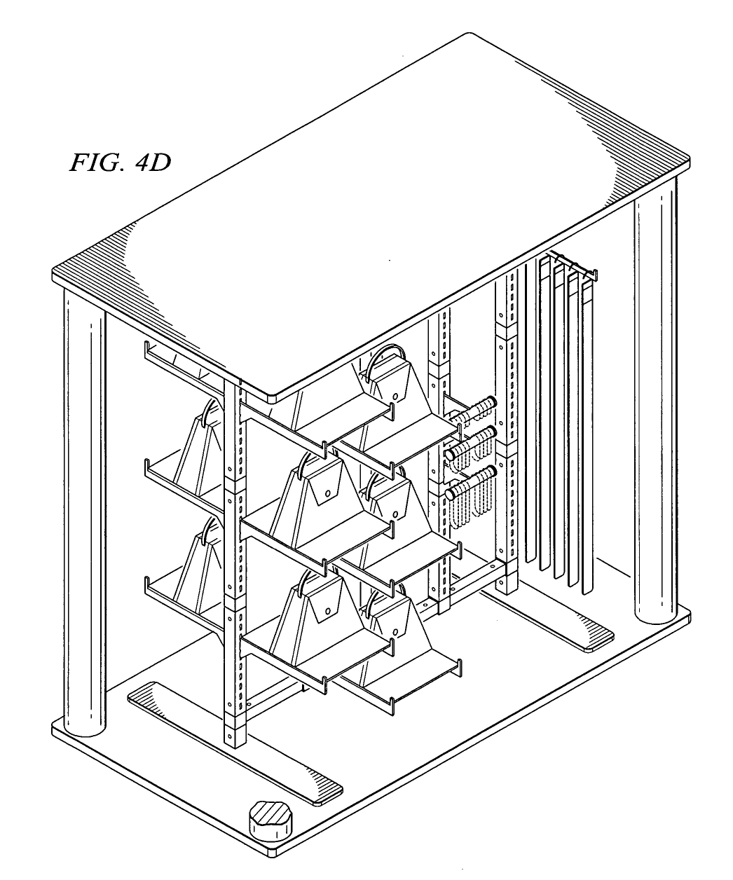

FIGS. 4A-4D show exemplary modular displays including both the structural support and display elements coupled thereto. FIGS. 4A and 4D illustrate the ability of a retailer to attach various design elements to the basic support structure shown in FIG. 3 in order to create unique displays that maintain a uniform appearance. FIGS. 4B and 4C further illustrate this concept and also illustrate the modularity of the vertical and horizontal members, allowing a retailer to create displays of varying shapes. FIGS. 4A-4D further illustrate the ability of the system to incorporate graphical elements in addition to the structural and display elements.

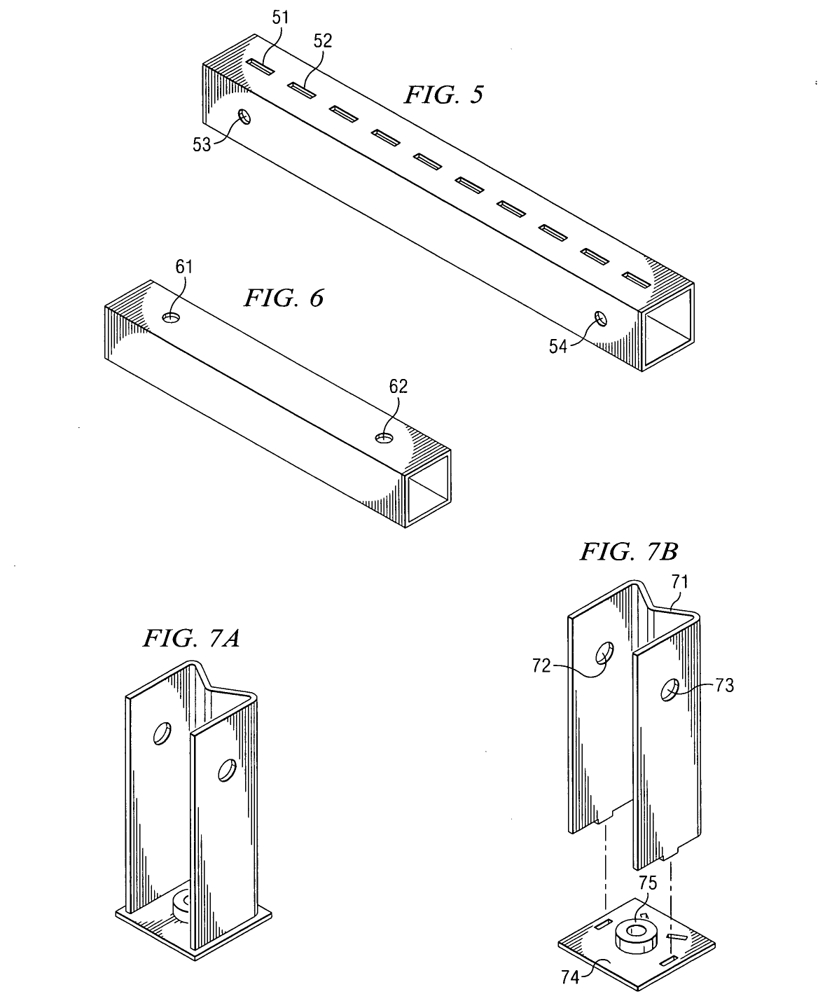

FIG. 5 shows an exemplary vertical member according to one embodiment such as vertical member 33 or 34 of FIG. 3. In one embodiment, the vertical member has a tube-like structure with a hollow interior and openings at opposing ends. The tube-like structure may possess various cross-sectional shapes. In one embodiment, the member may possess a square cross-sectional shape. Further, in one embodiment the vertical members have a different cross-sectional size or shape than the horizontal members in order to differentiate the two sets of members. In one embodiment, the members are of sufficiently short length that a retailer may easily change the size of a display by selectively adding or removing such members from the support structure. The member contains through-surface coupling portions 51 and 52 for attaching display elements to the vertical member. In one embodiment, connector elements 51 and 52 are female slots designed to accept industry-standard male connectors. Connector elements 51 and 52 may appear on more than one face of the member. In one embodiment, the vertical member has connector elements 51 and 52 on two opposing sides of a square cross-section member. The vertical member also contains connection elements 53 and 54 for securely attaching the vertical member to a connector. In one embodiment, these elements are also present on the opposite face of the member. In one embodiment, connection elements 53 and 54 are circular holes designed to fit industry-standard removable rivets.

FIG. 6 shows an exemplary horizontal member of a modular support structure according one embodiment such as horizontal members 31, 32 of FIGS. 3. In one embodiment, the horizontal member possesses a tube-like structure with a hollow interior and openings at opposing ends. The tube-like structure may possess various cross-sectional shapes. In one embodiment, the horizontal member may possess a square cross-sectional shape. Further, in one embodiment the horizontal members have a different cross-section size than the vertical members in order to differentiate the two sets of members. In one embodiment, the members are of sufficiently short length that a retailer may easily change the size of a display by adding or removing members. The horizontal member may contain display connection elements. In the exemplary embodiment shown in FIG. 6, however, the horizontal member does not contain display connection elements. The horizontal member contains connection elements 61 and 62 for securely attaching the horizontal member to a connector. In one embodiment, these elements are also present on the opposite face of the member. In one embodiment, connection elements 61 and 62 are circular holes designed to fit industry-standard removable rivets.

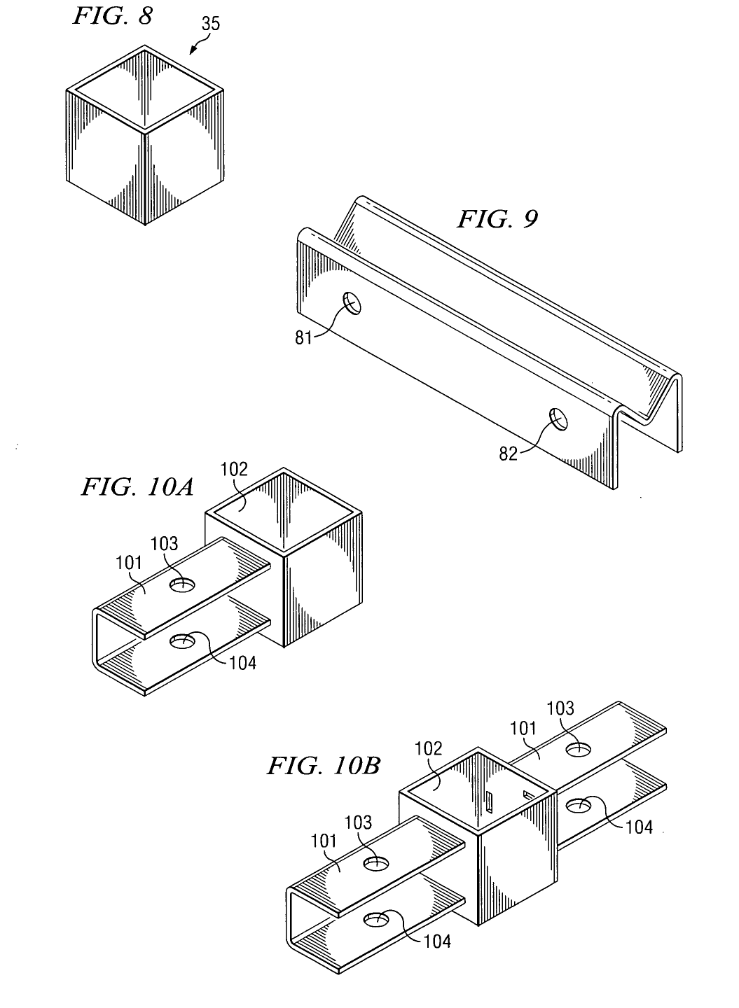

FIGS. 7A and 7B show an exemplary one way connector according to one embodiment. FIG. 7A shows a single one-way connector while FIG. 7B shows an exploded view of the connector components. Preferably, a retailer does not receive the component pieces shown in FIG. 7B, but rather receives the completed part shown in FIG. 7A. Turning to FIG. 7B, a one-way connector contains a spline element 71 that couples to a member as well as a cap element 74 that provides a terminating plane for a column of one or more vertical member. This one-way connector may be used in some embodiments in conjunction with the spacer element of FIG. 8 to form a connector assembly. In one embodiment, the spline element 71 is shaped such that it fits within a tube-like member, but does not impede the attachment of display elements to the member's display connector elements (e.g., such as connection elements 51 and 52 of FIG. 5). In a preferred embodiment, spline 71 has an “M” shaped cross-section such that the spline does not encroach on the area directly underneath the slots in a vertical member where industry-standard brackets attach. By enabling the spline to penetrate relatively deeply into the vertical member without obstructing the couple of a male connector to the vertical member's female slots, greater stability is afforded. In some embodiments, spline 71 may be shaped to fit one of horizontal or vertical members, but not both. In a preferred embodiment spline 71 is shaped such that when it is attached to the member, there is a space between the end of the member and the cap element 74. To fill this space, the retailer places a spacer element shown in FIG. 8 over the spline between the members. In one embodiment, the spacer element is a hollow cube with opposing ends open with the same cross-sectional size as vertical member. The spline further has connection elements 72 and 73 for securely attaching a connector to a member. In one embodiment, connection 72 and 73 elements are circular holes designed to fit industry-standard removable rivets. In one embodiment, cap 74 may contain a display connector element for connecting a display element to the cap. In a preferred embodiment, this display connector element is a pressed-in-metal (PIM) nut that accepts a product display stand. Such PIM nuts are standard in the industry.

To create a capped vertical member according to one embodiment, a retailer places a spacer element shown in FIG. 8 on top of a vertical member. The retailer then inserts spline element 71 of the one way connector through the spacer element into the vertical member. To complete the assembly, the retailer secures the connector by placing industry-standard removable rivets through the connection elements of the vertical member (e.g., connection element 53 of FIG. 5) and the connection elements of spline 71 (e.g., connection elements 72 and 73).

FIG. 9 shows an exemplary two-way connector according to the preferred embodiment. In one embodiment, a retailer uses a two-way connector to connect two members of the same type. In FIG. 9, the two-way connector is embodied as a spline that fits within an opening at the end of two members. In one embodiment, the spline is shaped such that it fits within a tube-like member, but does not impede the attachment of display elements to the member's display connector elements. In the preferred embodiment, the spline has an “M”-shaped cross-section such that the spline does not encroach on the area directly underneath slot openings in a member where industry-standard brackets rest. In some embodiments, the spline may be shaped to fit one of horizontal or vertical members, but not both. In the preferred embodiment the spline is shaped such that when the spline is attached to two members, there is a space between the two members. To fill this space, the retailer places a spacer element shown in FIG. 8 over the spline between the members. The spline contains connection elements 81 and 82 for securely attaching each member to the spline. In one embodiment, these elements are also present on the opposite face of the spline. Connection element 81 is used to attach the spline to one member and connection element 82 is used to attach the spline to another element. In one embodiment, these connection elements are circular holes designed to fit industry-standard removable rivets.

To create a straight section of two vertical members (i.e., a column) in the preferred embodiment, a retailer places a portion of the two-way connector's spline in an open end of a first vertical member and secures the spline to the member by placing industry-standard removable rivets through the connection elements of the vertical member and the connection elements of the spline. The retailer then places a spacer element over the spline resting on top of the first vertical member. The retailer would finally place the second member on top of the spacer element (with a portion of the spline penetrating into the second vertical element) and secure the spline to the second vertical member by placing industry-standard removable rivets through the connection elements of the second vertical member and the connection elements of the spline. The completed assembly of two vertical members 33 and 34 connected with a spline and spacer element 35 is shown in FIG. 3.

FIGS. 10A and 10B show an exemplary three-way connector and four-way connector respectively according to one embodiment. In one embodiment, a retailer uses a three-way connector in conjunction with other connectors to couple a member of one type (i.e., horizontal or vertical) to one or two members of the other type. Similarly, a retailer uses a four-way connector in conjunction with other connectors to couple two members of one type to one or two members of the other type. The invention also contemplates, however, a system in which a single element is used to connect three or four members together. Turning to FIGS. 10A and 10B, in one embodiment the three-and four-way connectors contain a spacer element 102 and one or two spline elements 101 for connecting to members of one type. In some embodiments, the spline may be shaped to fit one of horizontal or vertical members, but not both. Each spline 101 contains connection elements 103 and 104 for securely attaching each member to the spline. In one embodiment, connection elements 103 and 104 are circular holes designed to fit industry-standard removable rivets.

To create an “L”-shaped section of a support structure having a horizontal member and a vertical member according to one embodiment, a retailer uses a three-way connector and attach the horizontal member to the spline by sliding the spline into an open end of the horizontal member and securing the member by placing industry-standard removable rivets through the connection elements of the spline and the connection elements of the member. The retailer then attaches the vertical element to the three-way connector using a one-way connector and the procedure detailed above for attaching a one-way connector where the spacer element 102 on the three-way connector substitutes for an independent spacer element.

To create a “T”-shaped section of a support structure having two vertical members and a horizontal member according to the preferred embodiment, a retailer connects the horizontal member to a three-way connector in the same way as described above, and then connects the two horizontal members with a two-way connector as described above using the spacer element 102 on the three-way connector in place of an independent spacer element.

To create a “T”-shaped section of support structure having two horizontal members and a vertical member according to the preferred embodiment, a retailer places a horizontal member on each of the splines of a four-way connector by sliding the spline into an open end of the horizontal member and securing the member by placing industry-standard removable rivets through the connection elements of the spline and the connection elements of the member. The retailer would then attach the vertical element to the three-way connector using a one-way connector using the procedure detailed above for attaching a one-way connector where the spacer element 102 on the four-way connector substitutes for an independent spacer element.

To create a cross-section of support structure having two horizontal members and two vertical members, a retailer places a horizontal member on each of the splines of a four way connector by sliding the spline into an open end of the horizontal member and securing the member by placing industry-standard removable rivets through the connection elements of the spline and the connection elements of the member. The retailer then connects the two vertical members using a two-way connector as discussed above where the spacer element 102 on the four-way connector substitutes for an independent spacer element.

Embodiments of the present invention further contemplate four-and five-way connectors. In one embodiment, these connections would have the same structure as the three-and four-way connections of FIG. 9 and FIG. 10 with additional splines attached to the spacer element.

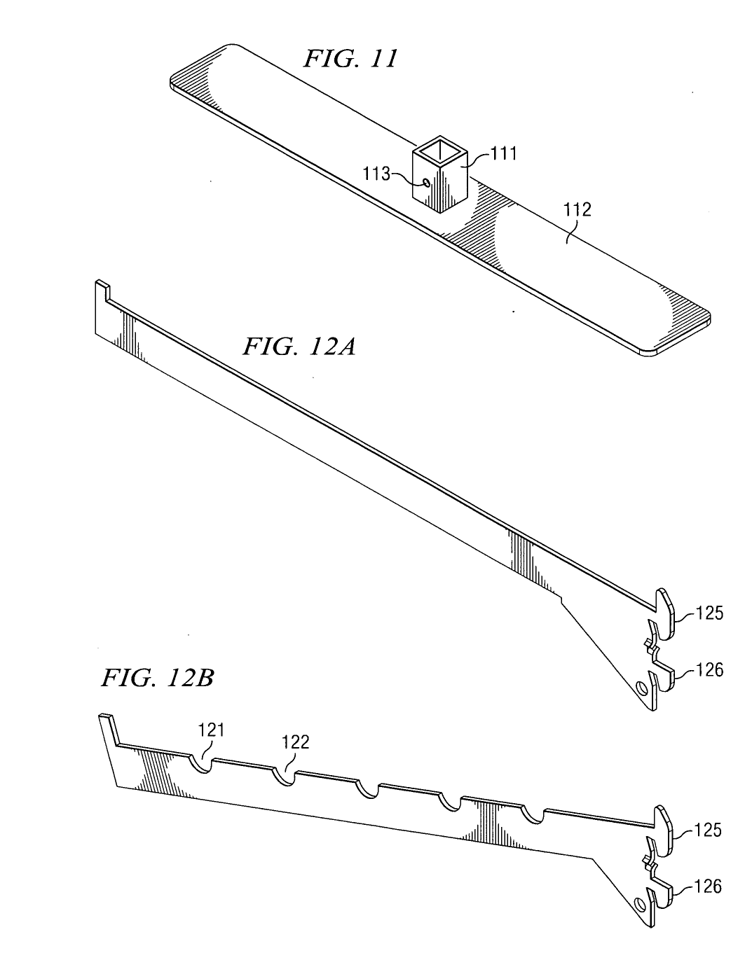

FIG. 11 shows an exemplary base assembly according to the one embodiment. The base assembly connects to the rest of the support structure and enables the support structure to stand upright. The base assembly includes a foot 112 and a connector module 111. In one embodiment the foot 112 is a flat rectangular sheet designed to fit on the main countertop of an RMU. In one embodiment, connector module 111 is a tube-like structure with the same dimensions as a vertical member, allowing the connection module to blend in with the rest of the structure. Connector module 111 contains connection elements 113 for connecting to structure members. In one embodiment, these connection elements 113 are circular holes designed to fit industry-standard removable rivets. To attach the base assembly to the remaining structure in one embodiment, the retailer simply uses any one of the connectors and procedures described above substituting the connector module 111 for a vertical member. In one embodiment, the base assembly provided to users may comprise a number of components fused together in order to increase stability of the unit. By way of example, the retailer may be provided with the base assembly shown in FIG. 11 fused with a three-way connector shown FIG. 10A and further fused with a vertical member shown in FIG. 5 connected to the base assembly through the three-way connector with a two way connector shown in FIG. 9.

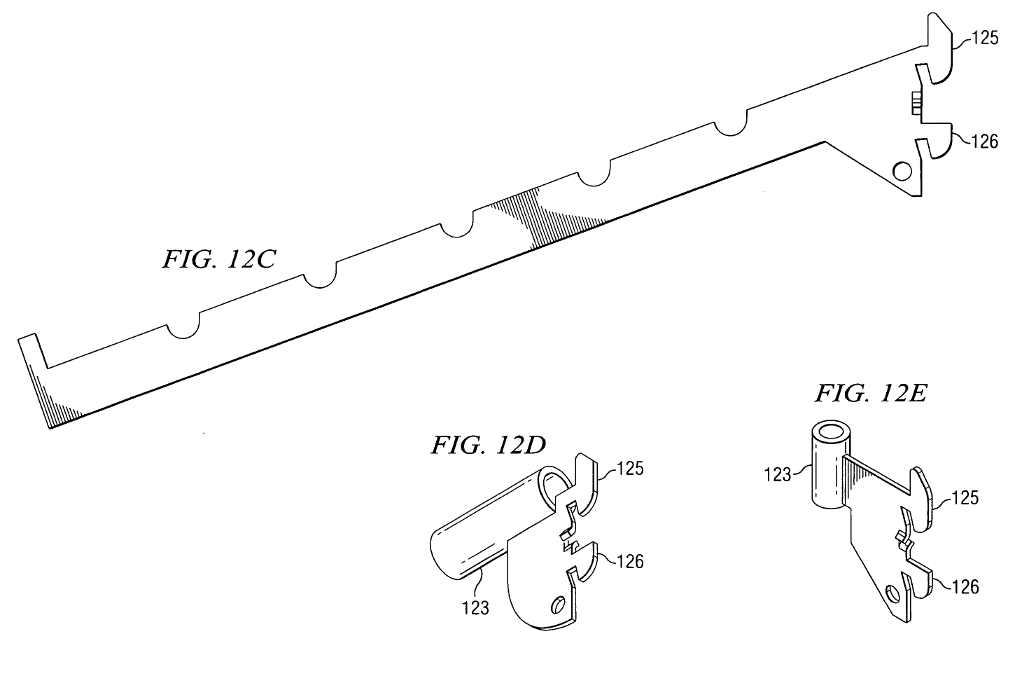

FIGS. 12A-12E show exemplary display elements according to one embodiment. “Display elements” refer to anything that attaches to the display support structure for displaying merchandise and/or information. FIGS. 12A-12E show display elements that attach to the industry-standard female slots of one embodiment. FIG. 12A shows a straight bracket on which shelves or other display elements may be mounted. Male connectors 125 and 126 connect to female slots of the support structure in a known way FIGS. 12B and 12C show an angled bracket, or waterfall. This bracket may support a shelf as shown in FIG. 4A or may display bracelets in the indentures 121 and 122 of the bracket. FIGS. 12D and 12E show display elements that connect to the display structure using bracket slots and then provide a further connection 123 for additional display elements. FIG. 12D contains a connector 123 that connects with jewelry bars to display jewelry, as shown in FIGS. 4B and 4D. FIG. 12E contains a connector 124 for connection with an armature arm as seen in FIGS. 4B, 4C, and 4D. These armatures are discussed in further detail in the concurrently filed application [Attorney Docket Number 66477-P004US-10601573] titled “ROTATABLE CONNECTOR FOR A DISPLAY SYSTEM”.

One embodiment provides connections for not only display elements such as those discussed above, but any display element that connects to a support structure using industry-standard brackets. The preferred embodiment also provides display element connectors on the cap of one-way connectors to attach display elements through a PIM nut. FIGS. 4B and 4C show circular shelving atop a vertical member attached to a one-way connector. As discussed above, the invention contemplates any number of types of display element connectors that may be present on vertical members, horizontal members, or any type of connector.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the apppended claims are intended to include within their scope such processes, machines, manufacture, compositions of matter, means, methods, or steps.

What is claimed is:

1. A modular display unit for displaying items comprising:
elongated hollow vertical members;
elongated hollow horizontal members;
connectors adapted to connect said horizontal members and said vertical members;
a base adapted to connect to at least one of said vertical members or one of said horizontal members by at least one of said connectors;
display elements to display items; and
means for attaching said display elements to said vertical members.

2. The display unit of claim 1 wherein said means for attaching said display elements to said vertical members comprises at least two apertures spaced intermittently along the longitudinal axis of said vertical members.

3. The display unit of claim 2 wherein at least one of said connectors comprises
an elongated element having a substantially M-shaped cross section adapted to be inserted into the open end of adjacent elongated hollow members to extend past at least the first of said apertures proximate said open end and adapted to permit insertion of a display element into said aperture proximate said open end.

4. The display unit of claim 2 wherein said means for attaching said display elements to said vertical members comprises at least two female slots spaced intermittently along the longitudinal axis of said vertical members, said slots adapted support a male connector portion of said display element.

5. A connector for connecting hollow elongated members having at least two apertures spaced intermittently along the longitudinal axis of at least one side of said hollow elongated members, said apertures adapted to connect display elements to said hollow elongated members, said connector comprising an elongated element having a substantially M-shaped cross section adapted to be inserted into one end of said elongated hollow member to extend past at least the first of said apertures proximate said one end and adapted to permit insertion of a display element into said aperture proximate said one end.

6. A connector for connecting hollow elongated members having at least two slots spaced intermittently along the longitudinal axis of at least one side of said hollow elongated members, said slots adapted to permit insertion of a display element, said connector comprising an elongated element having a substantially M-shaped cross section adapted to be inserted into one end of said elongated hollow member to extend past at least the first of said slots proximate said one end and adapted to permit insertion of a display element into said slot proximate said one end.

7. A modular display kit for displaying items comprising:
elongated hollow vertical members;
elongated hollow horizontal members;
connectors adapted to connected said horizontal members and said vertical members;
a base adapted to connect to at least one of said vertical members or one of said horizontal members by at least one of said connectors;
display elements to display items; and
means for attaching said display elements to said vertical members.

8. The display kit of claim 7 wherein said means for attaching said display elements to said vertical members comprises at least two apertures spaced intermittently along the longitudinal axis of said vertical members.

9. The display kit of claim 7 wherein said means for attaching said display elements to said vertical members comprises at least two slots spaced intermittently along the longitudinal axis of said vertical members, said slots adapted to support a male connector portion of said display element.

10. The display kit of claim 8 wherein at least one of said connectors comprises an elongated element having a substantially M-shaped cross section adapted to be inserted into one end of adjacent elongated hollow members to extend past at least the first of said apertures proximate said one end and adapted to permit insertion of a display element into said apertures proximate said one end.

11. The display kit of claim 9 wherein at least one of said connectors comprises an elongated element having a substantially M-shaped cross section adapted to be inserted into one end of adjacent elongated hollow members to extend past at least the first of said slots proximate said one end and adapted to permit insertion of a display element into said slot proximate said one end.

12. A method for assembling a modular display unit for displaying retail merchandise having hollow elongated vertical members with at least two apertures spaced intermittently along the longitudinal axis of at least one side of said hollow elongated vertical members, hollow elongated horizontal members, connectors adapted to connect said vertical and horizontal members, a base, and display elements having a male connector portion adapted for insertion into said apertures, comprising the steps of:
selecting at least one hollow elongated vertical member;
selecting at least one hollow elongated horizontal member;
connecting the base to a selected vertical member using a connector;
connecting hollow elongated vertical members to one another using connectors;
connecting hollow elongated horizontal members to one another using connectors;
connecting hollow elongated vertical members to hollow elongated horizontal members using connectors; and
attaching display elements to at least one of said plurality of hollow elongated vertical members by placing said male connector portion of said display element in said apertures of said hollow elongated vertical member.

13. The method of claim 12 wherein said hollow elongated vertical members and at least one of said connectors further comprise openings adapted to fit a securing element, said step of connecting hollow elongated vertical members to one another further comprising the steps of:
placing a connector inside one end of a first hollow elongated vertical member;
securing said connector to said first hollow elongated vertical member by lining up said openings in said connector with said openings in said first hollow elongated vertical member and inserting a securing element through said openings in said connector and said openings in said first member;
placing said connector connected to said first member inside one end of a second hollow elongated vertical member; and
securing said connector to said second member by lining up said openings in said connector with said openings in said second member and inserting a securing element through said openings in said connector and said openings in said second member.

14. The method of claim 12 wherein at least one of said connectors comprises an elongated element having a substantially M-shaped cross section, said step of connecting hollow elongated vertical members to one another further comprising the steps of:
inserting said connector into one end of said elongated hollow vertical member extending past at least the first of said apertures proximate said one end; and
positioning said connector within said one end of said elongated hollow vertical member such that said connector permits insertion of a said male connector portion of said display element into said aperture proximate said one end.

15. A method for assembling a modular display unit for displaying retail merchandise having a plurality of hollow elongated vertical members with at least two slots spaced intermittently along the longitudinal axis of at least one side of said hollow elongated vertical members, hollow elongated horizontal members, connectors adapted to connect said vertical and horizontal members, a base, and display elements having a male connector portion adapted for insertion into said slots, comprising the steps of:
selecting at least one hollow elongated vertical member;
selecting at least one hollow elongated horizontal member;
connecting the base to a selected vertical member using a connector;
connecting hollow elongated vertical members to one another using connectors;
connecting hollow elongated horizontal members to one another using connectors;
connecting hollow elongated vertical members to hollow elongated horizontal members using connectors; and
attaching display elements by placing said male connector portion of said display element in said slot of said hollow elongated vertical member.

16. The method claim 15 wherein said hollow elongated vertical members and at least one of said connectors further comprise openings adapted to fit a securing element, said step of connecting hollow elongated vertical members to one another further comprising the steps of:
placing a connector inside one end of a first hollow elongated vertical member;
securing said connector to said first member by lining up said openings in said connector with said openings in said first member and inserting a securing element through said openings in said connector and said openings in said first member;
placing said connector connected to said first member inside one end of said second hollow elongated vertical member; and
securing said connector to said second member by lining up said openings in said connector with said openings in said second member and inserting a securing element through said openings in said connector and said openings in said member.

17. The method of claim 15 wherein at least one of said connectors comprises an elongated element having a substantially M-shaped cross section, said step of connecting hollow elongated vertical members to one another further comprising the steps of:
inserting said connector into one end of said elongated hollow vertical member extending past at least the first of said apertures proximate said one end; and
positioning said connector within said one end of said elongated hollow vertical member such that said connector permits insertion of a said male connector portion of said display element into said slots proximate said open end.
